(19) United States
(12) Patent Application Publication
(10) Pub. No.: US 2007/0290776 A1
(43) Pub. Date: Dec. 20, 2007

(54) Time delay relay

(76) Inventors: Tim Hasenour, Clemmons, NC (US); David Parker, Shelby, NC (US); Kurt T. Zarbock, Advance, NC (US)

Correspondence Address: Helen Odar Wolstoncroft;Tyco Electronics Corporation, Suite 140, 4550 New Linden Hill Road, Wilmington, DE, 19808-2952, US

(21) Appl. No.: 11/825,930

(22) Filed: Jul. 9, 2007

Related U.S. Application Data
(63) Continuation of application No. 11/454,217, filed on Jun. 17, 2006, now abandoned.

(51) Int. Cl. H01H 7/00; H01H 7/02

(52) U.S. Cl. 335/62; 335/63

(57) ABSTRACT

A time delay relay includes a coil having a longitudinal axis therethrough and an armature proximate an end of the coil. The armature is movable between an energized position and a de-energized position. A tube is positioned within the coil. The tube has a longitudinal axis that is substantially coincident with the axis of the coil. A metallic core is disposed within the tube. The core is movable along the longitudinal axis of the tube in response to a magnetic field in the coil to induce movement of the armature to the energized position. A time delay occurs between the onset of the presence of the magnetic field and the movement of the armature to the energized position.

### CROSS REFERENCE TO RELATED APPLICATIONS

This application is a continuation of U.S. application Ser. No. 11/454,217, filed Jun. 17, 2006, and entitled “Time Delay Relay”, which is hereby incorporated by reference in its entirety.

### BACKGROUND OF THE INVENTION

The invention relates generally to electromagnetic relays, and more specifically, to a relay having a time delay in the actuation of the relay.

A typical electromagnetic relay includes a contact mounted on an armature that is held in an open position by a spring. A coil wound core attracts the armature to the core when sufficient current is passed through the coil to energize the core to overcome the spring and attract the armature to the core.

In some applications, it may be desirable to have a time delay in the actuation of a relay. For instance, in the case of an electric motor, such as in a hand held power tool, it may be advantageous to have a time delay before full power is applied to the motor. As an example, a time delay relay may be used in parallel with a current limiting resistor. The current limiting resistor limits the current to a motor when the motor is switched on providing a soft start. After a time delay, the relay shorts out the resistor making full power available to the motor.

In a typical time delay relay, the time delay is achieved electronically, such as through the addition of capacitor delay circuitry, a time delay integrated circuit, or the like. Such relays, however, have various shortcomings. The electronics added to provide the time delay function increases both the cost and complexity of the relay. In addition, the size of the relay may also be increased.

A need remains for a time delay relay that is simply constructed and that can be economically produced. Further, a need remains for a time delay relay that will fit in the packages of current relays that do not include a time delay.

### BRIEF DESCRIPTION OF THE INVENTION

In one aspect, a time delay relay is provided. The relay includes a coil having a longitudinal axis therethrough and an armature proximate an end of the coil. The armature is movable between an energized position and a de-energized position. A tube is positioned within the coil. The tube has a longitudinal axis that is substantially coincident with the axis of the coil. A metallic core is disposed within the tube. The core is movable along the longitudinal axis of the tube in response to a magnetic field in the coil to induce movement of the armature to the energized position. A time delay occurs between the onset of the presence of the magnetic field and the movement of the armature to the energized position.

Optionally, the delay relay also includes a yoke and a biasing member between the yoke and the armature. The biasing member biases the armature toward the de-energized position. A movable contact is mounted on the biasing member, and the coil is wound about a bobbin having a fixed contact mounted thereon. The core is movable within the tube between an energized position and a de-energized position. The tube includes a biasing element that biases the core toward the de-energized position. The tube is closed and is filled with a hydraulic fluid.

In another aspect, a time delay relay is provided that includes a coil having a longitudinal axis therethrough and an armature proximate an end of the coil. The armature is movable between an energized position and a de-energized position. A tube is positioned within the coil. The tube has a longitudinal axis that is substantially coincident with the axis of the coil. A metallic core is disposed within the tube. The core is movable along the longitudinal axis of the tube in response to a magnetic field in the coil to induce movement of the armature to the energized position after a time delay. The time delay is mechanically determined by the time required for the core to move from a de-energized position wherein the core is not centered within the coil to an energized position wherein the core is substantially centered within the coil.

### BRIEF DESCRIPTION OF THE DRAWINGS

FIG. 1 is a cross-sectional view of a known electromagnetic relay.

FIG. 2 is a perspective view of a time delay relay formed in accordance with an exemplary embodiment of the present invention.

FIG. 3 is a cross-sectional view of the relay shown in FIG. 2 taken along the line 3-3 shown in a de-energized state.

FIG. 4 is a cross-sectional view of the relay shown in FIG. 2 taken along the line 3-3 and shown in an energized state.

FIG. 5 is a cross-sectional view of a relay formed in accordance with an alternative embodiment of the present invention.

FIG. 6 is a cross-sectional view of the relay shown in FIG. 5 in an energized state.

### DETAILED DESCRIPTION OF THE INVENTION

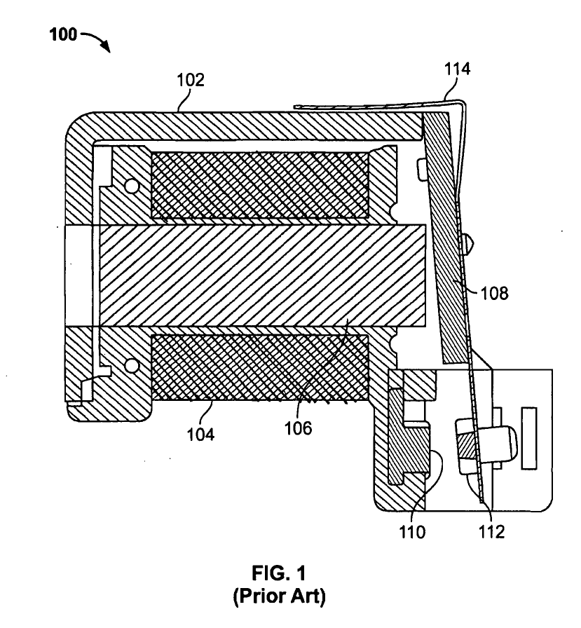

FIG. 1 is a cross-sectional view of a known electromagnetic relay 100 having no actuation time delay. Relay 100 includes a yoke 102, a coil 104 that surrounds a core 106, and a movable armature 108. Relay 100 includes a stationary contact 110 and a movable contact 112 that is attached to a spring 114. The spring 114 biases the armature 108 away from the core 106 so that the contacts 110 and 112 are normally open. When sufficient current is present in the coil 104, the relay 100 is energized and the armature 108 is magnetically attracted to the core 106 moving the armature 108 toward the core 106 and moving the movable contact 112 into engagement with the stationary contact 110.

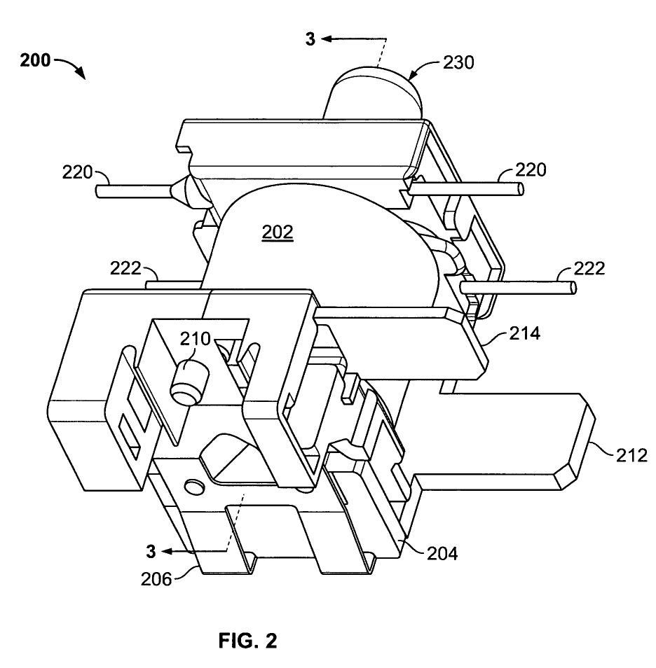

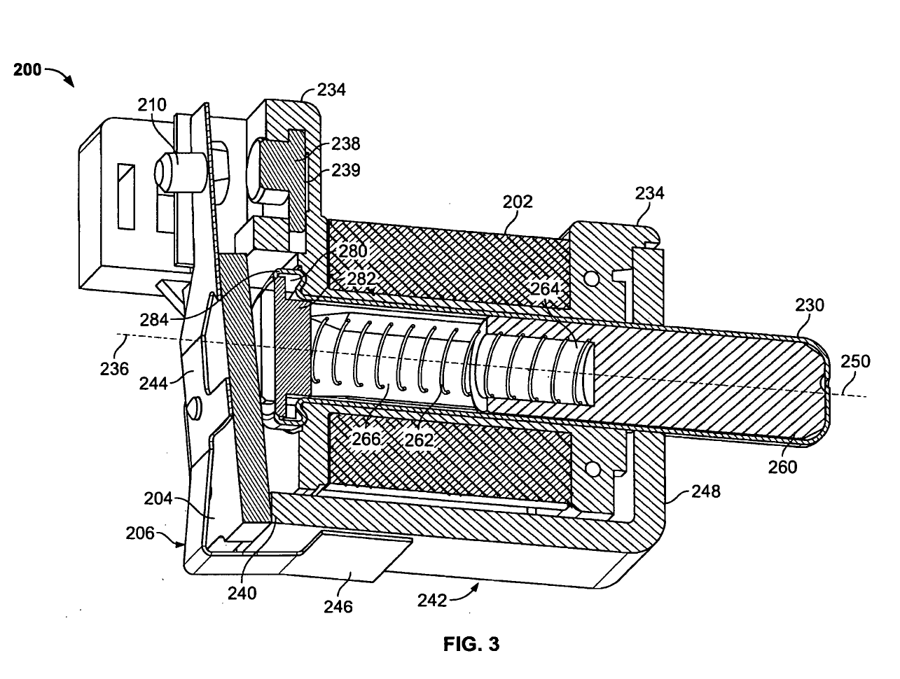

FIG. 2 illustrates a perspective view of a time delay relay 200 formed in accordance with an exemplary embodiment of the present invention. The relay 200 includes a coil 202 and an armature 204. A biasing member 206, which in some embodiments is a flat spring, biases the armature 204 away from a core 260 (see FIG. 3) and also carries a movable contact 210. A source or power connection is made to the relay 200 through a tab 212 that is also electrically connected to the armature 204, the biasing member 206, and the contact 210. A second tab 214 is electrically connected to a fixed contact 238 (see FIG. 3). Pins 220 and 222 are provided for coil connections and also for printed circuit board connections or other outside connections to the coil 202. A cylinder or tube 230 extends beyond the coil 202.

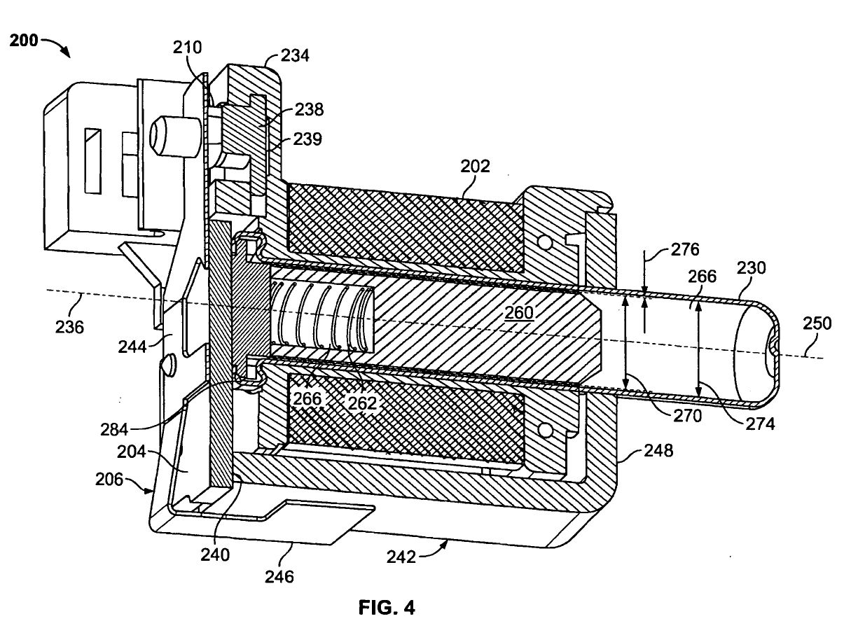

FIG. 3 illustrates a cross sectional view of the relay 200 in a de-energized state. FIG. 4 illustrates a cross sectional view of the relay 200 in an energized state. The coil 202 is wound about a bobbin 234 and has a longitudinal axis 236. The bobbin 234 is molded from a dielectric material. In the illustrated embodiment, a fixed contact 238 is mounted on the bobbin 234. A conductive strip 239 provides a conductive path from the fixed contact 238 to the tab 214 (FIG. 2). The fixed contact 238 is aligned for engagement with the movable contact 210 when the relay 200 is energized. The armature 204 pivots about an end 240 of a yoke 242 between a de-energized position, as shown in FIG. 3, and an energized position wherein the movable contact 210 engages the fixed contact 238 as depicted in FIG. 4. The biasing member 206 has an end 244 attached to the armature 204 and a second end 246 that is attached to the yoke 242 such that the biasing member 206 biases the armature toward the de-energized position.

The tube 230 extends beyond the coil 202, bobbin 234 and a bottom end 248 of the yoke 242. The tube 230 has a longitudinal axis 250 that substantially coincides with the longitudinal axis 236 of the coil 202. The tube 230 contains a core 260 that is movable between a de-energized position, as shown in FIG. 3, and an energized position, as shown in FIG. 4. A biasing element 262 is provided to bias the core 260 toward the de-energized position. The core 260 may include a cavity 264 that receives an end of the biasing element 262. The tube 230 is fabricated from a non-magnetic material. In an exemplary embodiment, tube 230 is of brass construction. The tube 230 is closed and is filled with a hydraulic fluid 266. With reference to FIG. 4, the core 260 has an outside diameter 270 and the tube 230 has an internal diameter 274. A clearance gap 276 is provided inside the tube 230 that is determined by the difference in the tube internal diameter 274 and the core outer diameter 270. In an exemplary embodiment, the core outer diameter is about 0.1485 inches, the tube inner diameter is about 0.156 inches, and the clearance gap is about 0.004 inches. A seal 280 and a core cap 282 are installed at the open end of the tube 230 to close the tube 230. The tube 230 is oriented such that the core cap 282 is proximate the armature 204. In one embodiment, a lip 284 on the tube 230 is crimped over the core cap 282 to retain the core cap 282 and seal 280.

In operation, a current is applied to the coil 202 to energize the relay 200. In the de-energized position, the core 260 is partially within and partially outside the coil's magnetic field. The magnetic field in the coil 202 induces the core 260 to move toward the core cap 282 to center itself in the coil's magnetic field. The core 260 is sized such that when centered in the magnetic field, the core 260 engages the core cap 282. The armature 204 is then pulled from its de-energized position toward the core cap 282 to an energized position closing the contacts 210 and 238. The time between the onset of the magnetic field in the coil 202 and the movement of the armature 204 to its energized position closing the contacts 210 and 238 represents the time delay that is provided by the relay 200. Thus, the time delay is mechanically determined and results from the time required for the core 260 to move from a de-energized position wherein the core 260 is not centered within the coil 202 to an energized position wherein the core 260 is substantially centered within the coil 202. When the core 260 is substantially centered, it also engages the core cap 282 to initiate actuation of the armature 204.

When current flow through the coil 202 is turned off so that the magnetic field is no longer present, biasing element 262 returns the core 260 to its de-energized position. Simultaneously, the biasing member 206 returns the armature 204 to its de-energized position opening the contacts 210 and 238. The hydraulic fluid 266 is displaced by flowing through the clearance gap 276 as the core 260 moves through the hydraulic fluid 266. The time delay in the relay 200 is influenced by the viscosity of the hydraulic fluid 266 as well the dimensions of the tube 230 and the core 260. As an example, at the tube 230 and core 260 diameters previously mentioned, a hydraulic fluid viscosity of about 25 centistokes yields a time delay of about 600 milliseconds. It should be noted that the FIGS. 2-4 represent enlarged views of the time delay relay 200. For proper perspective, about eight drops of hydraulic fluid fills the tube 230 when the core 260 and biasing element 262 are installed.

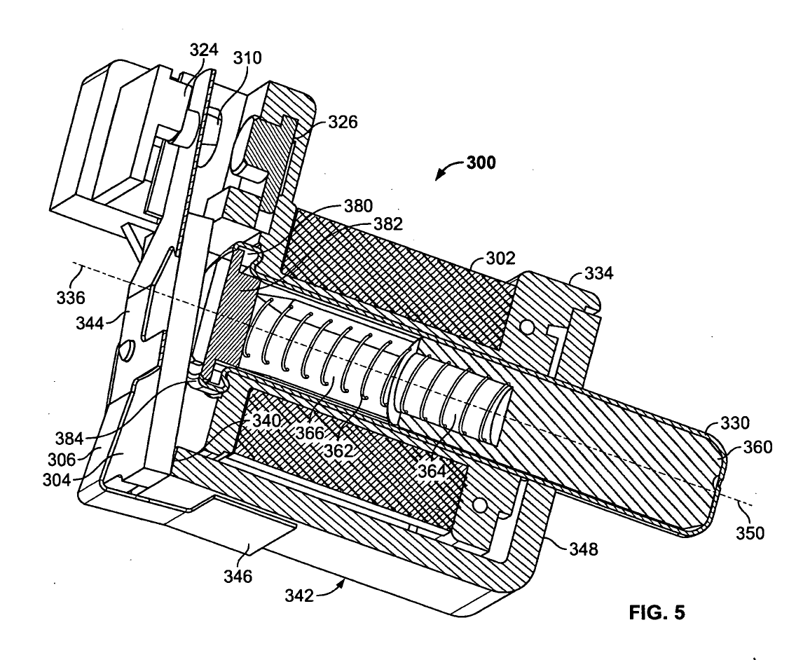

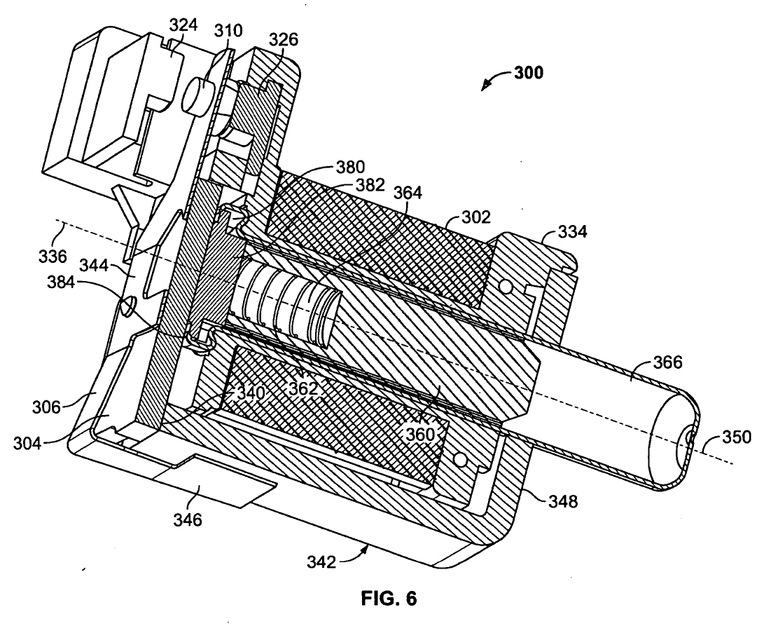

FIG. 5 illustrates a cross-sectional view of a relay 300 formed in accordance with an alternative embodiment of the present invention. In FIG. 5, the relay 300 is shown in a de-energized state. FIG. 6 illustrates a cross-sectional view of the relay 300 in an energized state. The relay 300 includes both normally open contacts and normally closed contacts as will be described. In other respects, the relay 300 is similar to the relay 200 previously described, and like reference numbering is generally used in describing like components.

The relay 300 includes a coil 302 and an armature 304. A spring 306 carries a movable contact 310. A normally closed fixed contact 324 electrically engages the movable contact 310 when the relay 300 is de-energized. A normally open fixed contact 326 electrically engages the movable contact 310 when the relay 300 is energized. A tube 330 extends beyond the coil 302. The coil 302 is wound about a bobbin 334 and has a longitudinal axis 336. The normally open fixed contact 326 is mounted on the bobbin 334 and is aligned for engagement with the movable contact 310 when the relay 300 is energized. The armature 304 pivots about an end 340 of a yoke 342 between a de-energized position, as shown in FIG. 5, and an energized position, as depicted in FIG. 6. The biasing member 306 has an end 344 attached to the armature 304 and a second end 346 that is attached to the yoke 342 such that the biasing member 306 biases the armature toward the de-energized position wherein the movable contact 310 engages the normally closed fixed contact 324.

The tube 330 extends beyond the coil 302, bobbin 334 and a bottom end 348 of the yoke 342. The tube 330 has a longitudinal axis 350 that substantially coincides with the longitudinal axis 336 of the coil 302. The tube 330 contains a core 360 that is movable between a de-energized position (FIG. 5) and an energized position (FIG. 6). The spring 306 biases the armature away from the core 360. A biasing element 362 is provided to bias the core 360 toward the de-energized position. The core 360 may include a cavity 364 that receives an end of the biasing element 362. The tube 330 is fabricated from a non-magnetic material. In an exemplary embodiment, tube 330 is of brass construction. The tube 330 is closed and is filled with a hydraulic fluid 366. A seal 380 and a core cap 382 are installed at the open end of the tube 330 to close the tube 330. The tube 330 is oriented such that the core cap 382 is proximate the armature 304. In one embodiment, a lip 384 on the tube 330 is crimped over the core cap 382 to retain the core cap 382 and seal 380.

In operation, when a current is applied to the coil 302 to energize the relay 300, the magnetic field in the coil 302 induces the core 360 to move toward the core cap 382 to center itself in the coil's magnetic field. The core 360 is sized such that when centered in the magnetic field, the core 360 engages the core cap 382. The armature 304 is then pulled from its de-energized position toward the core cap 382 to an energized position, opening the connection between the movable contact 310 and the normally closed fixed contact 324 and establishing an electrical connection between the movable contact 310 and the normally open fixed contact 326. The time between the onset of the magnetic field in the coil 302 and the movement of the armature 304 to its energized position represents the time delay that is provided by the relay 300. Thus, the time delay is mechanically determined and results from the time required for the core 360 to move from a de-energized position wherein the core 360 is not centered within the coil 302 to an energized position wherein the core 360 is substantially centered within the coil 302. When the core 360 is substantially centered, it also engages the core cap 382 to initiate actuation of the armature 304.

When current flow through the coil 302 is turned off so that the magnetic field is no longer present, biasing element 362 returns the core 360 to its de-energized position. Simultaneously, the biasing member 306 returns the armature 304 to its de-energized position opening the connection between the movable contact 310 and the normally open fixed contact 326 and re-establishing the connection between the movable contact 310 and the normally closed fixed contact 324.

The embodiments thus described provide a simple, compact, and low cost time delay relay. The time delay is mechanically produced by replacing the steel core of a standard relay with a tube or cylinder containing a movable core in a hydraulic fluid to provide a predetermined delay. Thus, the cost of additional electronics is avoided. In addition, other than the slight extension of the hydraulic tube, the size of the relay package is not appreciably increased.

While the invention has been described in terms of various specific embodiments, those skilled in the art will recognize that the invention can be practiced with modification within the spirit and scope of the claims.

1-19. (canceled)

20. A method for controlling an electric power tool to provide a soft start, comprising:
providing a power tool, having a motor and a motor circuit, the motor circuit including a current limiting element that limits current to the motor;
coupling a time delay relay in the motor circuit to bypass the current limiting element when the time delay relay is energized to provide full power to the motor after a time delay, the time delay relay comprising a coil having a longitudinal axis therethrough;
an armature proximate an end of said coil, said armature being movable between an energized position and a de-energized position;
a tube positioned within said coil, said tube having a longitudinal axis that is substantially coincident with said axis of said coil; and
a metallic core disposed within said tube, said core being movable along said longitudinal axis of said tube in response to a magnetic field in said coil to induce movement of said armature to said energized position, wherein a time delay occurs between the onset of the presence of the magnetic field and the movement of said armature to said energized position.

21. The method of claim 20, wherein the current limiting element comprises a resistance so that full current to the motor is prevented when the time delay relay is not energized.

22. The method of claim 20, wherein the current limiting element comprises a resistance in series with the motor windings.

23. The method of claim 20, wherein coupling the time delay relay in the motor circuit includes connecting the time delay relay in parallel with the current limiting element so that the current limiting element is shorted when the time delay relay is energized.

24. The method of claim 20, wherein the tube is filled with a hydraulic fluid.

25. The method of claim 24, wherein the hydraulic fluid has a viscosity selected to provide a predetermined time delay.

26. The method of claim 24, wherein the tube is positioned such that the tube extends from the coil.

27. The method of claim 20, wherein disposing the core in the tube includes disposing the core in the tube so that the core is not centered relative to the coil when the time delay relay is not energized.

28. The method of claim 20, wherein disposing the core in the tube includes disposing the core in the tube so that the core moves toward a centered position in the coil to actuate the relay when the relay is energized.

29. The method of claim 20, wherein the time delay is determined by the time required for the core to move to the centered position and for contacts in the relay to close after power is applied to the motor.

30. The method of claim 20, the time delay relay further comprising a yoke and a biasing member between said yoke and said armature, said biasing member biasing said armature toward said de-energized position.

31. The method of claim 20 further comprising a yoke and a biasing member between said yoke and said armature, and a movable contact mounted on said biasing member, and wherein said coil is wound about a bobbin having a fixed contact mounted thereon, said movable contact engaging said fixed contact when said armature is moved to said energized position.

32. The method of claim 20, further comprising moving the core within said tube between an energized position and a de-energized position and said tube includes a biasing element biasing said core toward said de-energized position.

33. A method for controlling an electric power tool to provide a soft start comprising:
providing a power tool with a motor and a motor circuit, the motor circuit having a current limiting element that limits current to the motor;
providing a relay having a metallic core that is movable from a de-energized position to an energized position to provide a mechanically controlled time delay represented by the time required for the core to move from the de-energized position to the energized position and for contacts in the relay to close; and
coupling the relay in the motor circuit so that the current limiting element is bypassed after the core moves from the de-energized position to the energized position so that full power is available to the motor.

34. The method of claim 33, wherein wiring a current limiting element in the motor circuit comprises wiring the current limiting element to limit the current to the motor.

35. The method of claim 33, wherein wiring the relay in the motor circuit includes wiring the relay in parallel with the resistance so that the current limiting element is shorted when the relay is energized.

36. The method of claim 33, wherein providing a relay having a metallic core that is movable from a de-energized position to an energized position comprises providing a relay having a core disposed within a tube containing a hydraulic fluid.

37. The method of claim 36, wherein the relay includes a coil and wherein providing a relay having a core disposed within a tube includes positioning the tube such that the tube extends from the coil.

38. The method of claim 37, wherein positioning the tube such that the tube extends from the coil includes positioning the tube so that the core is not centered in the coil when the relay is not energized.

39. The method of claim 38, wherein positioning the tube so that the core is not centered in the coil when the relay is not energized includes providing a biasing member to bias the core toward the de-energized position.

40. The method of claim 37, wherein positioning the tube such that the tube extends from the coil includes positioning the tube so that the core moves toward a centered position in the coil when the relay is energized to actuate the relay.
